(19) United States
(12) Patent Application Publication
(10) Pub. No.: US 2008/0295457 A1
(43) Pub. Date: Dec. 4, 2008

(54) FRAGRANCE ENHANCED ARTICLES AND METHODS

(76) Inventors: Vida S. Kaniecki, Pittsburgh, PA (US); Tom Davis, Wexford, PA (US)

Correspondence Address: FERENCE & ASSOCIATES LLC, 409 BROAD STREET, PITTSBURGH, PA, 15143, US

(21) Appl. No.: 12/026,934

(22) Filed: Feb. 6, 2008

Related U.S. Application Data
(60) Provisional application No. 60/888,533, filed on Feb. 6, 2007.

(51) Int. Cl. B65B 63/00; B32B 27/06; C08J 5/00; A44C 15/00

(52) U.S. Cl. 53/428; 428/321.5; 264/239

(57) ABSTRACT

The utilization of thermoplastic materials for fragrance tagging of products and fragrance enhanced packaging.

### CROSS-REFERENCE TO RELATED U.S. PATENT APPLICATION

This application claims priority from U.S. Provisional Patent Application No. 60/888,533 filed on Feb. 6, 2007 and is fully incorporated by reference as if fully set forth herein.

### FIELD OF THE INVENTION

The present invention relates generally to fragrance enhanced articles, and methods of making same.

### BACKGROUND OF THE INVENTION

The sense of smell plays a large role in our daily lives. Smell allows one to taste and to protect oneself. It evokes certain memories and can be used to create various moods and atmospheres. Fragrances and aromas are frequently used in marketing to sell a particular product, image, or lifestyle.

The use of fragrances in marketing, however, has encountered numerous pitfalls over the years. One common arrangement is “scratch and sniff”, where a spot or strip of “scratch and sniff” material is placed on a product package, piece of cardboard, a wall, etc., to help a consumer orient to a predetermined fragrance. However, the use of “scratch and sniff” is highly limited as the fragrance wears away after only a few “scratches”.

Many are also able to recount trips to a department store where highly enthusiastic, commission-based sales representatives at perfume counters will spare no effort to present fragrances to unwitting customers, e.g., by spraying a fragrance in a customer's general direction or coating a strip of cardboard with fragrance that is then to be presented, often unwittingly, to a close proximity of the customer's nose. While many customers are receptive to such highly proactive marketing efforts, many in fact are alienated or offended by such efforts. Thus, new manners of presenting fragrances to potential customers could be more effective in actually commanding customers' attention and increasing sales.

In view of the foregoing, a growing and compelling need has been recognized in connection with presenting scents and fragrances to consumers in a manner that is both effective in presentation as well as easy for consumers to assimilate.

### SUMMARY OF THE INVENTION

Broadly contemplated herein, in accordance with at least one presently preferred embodiment of the present invention, are methods and arrangements for employing thermoplastic materials for fragrance tagging of products and fragrance enhanced packaging.

In summary, one aspect of the invention provides a method of marking a product with scent, the method comprising the steps of: providing a product; providing a scent associated with the product; incorporating the scent into a thermoplastic, wherein the scent is distributed substantially evenly throughout the thermoplastic; obtaining a piece of the thermoplastic; and incorporating the piece of thermoplastic with the product.

Another aspect of the invention provides a method of providing a scent-enhanced product, the method comprising the steps of: providing a predetermined scent; incorporating the scent into a thermoplastic, wherein the scent is distributed substantially evenly throughout the thermoplastic; and forming the thermoplastic into a scent-enhanced product.

Furthermore, an additional aspect of the invention provides a scented material comprising: a predetermined encapsulated scent; and a thermoplastic; the scent being distributed substantially evenly throughout the thermoplastic.

For a better understanding of the present invention, together with other and further features and advantages thereof, reference is made to the following description, and the scope of the invention will be pointed out in the appended claims.

### BRIEF DESCRIPTION OF THE DRAWINGS

FIG. 1 depicts a product with a mounted tag comprising scented material.

FIG. 2 is a block diagram illustrating a process of formation of scented material.

### DETAILED DESCRIPTION OF THE PREFERRED EMBODIMENTS

As alluded to above, there is broadly contemplated herein the use of thermoplastics to assist in associating a fragrance with a product for presentation to consumers.

Generally, thermoplastics are polymers which melt at high temperatures and solidify at low temperatures. Within a certain temperature range, depending on the specific product, thermoplastics are elastic as well as flexible.

The first thermoplastic elastomer became available in 1959, and since that time a plethora of variations of materials has become available. Thermoplastic polymers include TPE (thermoplastic elastomer), TPU (thermoplastic urethane), and PU (polyurethane). Thermoplastics are manufactured by numerous companies including Bayer Material Sciences (BayerMaterialScienceNAFTA.com), GLS Corporation, and Teknor Apex Corporation.

TPU has the combined properties of plastics and rubber. Depending on the grade of product, TPU may manifest the consistency of a soft gel to hard plastic. This allows for TPU's versatile application in the marketplace where it is utilized in products as diverse as shoe insoles to tool handles and automobile dashboards.

Thermoplastics are able to be molded and remolded through injection molding and poured molding processes with repeated heating/cooling cycles, i.e., they are recyclable. This is in contrast to thermosetting polymers, which are not able to be remolded with reheating. Other attractive properties of TPU include its strength, flexibility, elasticity, and adhesiveness to various substrates, all of which add to its versatility. In addition, certain grades of TPU comply with FDA food-contact and biocompatibility requirements.

Broadly contemplated herein, in accordance with at least one presently preferred embodiment of the present invention, is the concept of capturing scents or fragrances within and throughout thermoplastic material. Generally, scented TPU/TPE/PU has not heretofore been used for producing fragrance tagged products or fragrance enhanced packaging. Thus, there exists a need in the art for fragrance tagged products or fragrance enhanced packaging produced using scented TPU/TPE/PU.

The use of fragrance in consumer products is commonplace. However, scented primary and secondary packaging is not currently in use. For example, in the personal hygiene department, one brand of shampoo, lotion, or even feminine care product may be available in multiple different scents. With current packaging practices, frequently the only way to select among the different fragrances is to open the packaging/bottle/jar and smell. This may lead to contamination, loss of product, and/or destruction of packaging such that the product is no longer sellable resulting in product wastage with increased costs transferred to consumers.

With fragrance enhanced packaging, TPU/TPE scented with the product fragrance can preferably be incorporated directly into the packaging. This may be done simply with a piece of scented gel material (such as a disc) applied to the box/bottle/jar. On the other hand, a harder grade TPU/TPE may be used and manufactured directly into a portion of the product container itself if no external packaging is utilized. While certain companies have utilized “scratch and sniff” stickers, scented TPU/TPE has the advantage of durability and fragrance permanence.

At the same time, just as product packaging can be scented, fragrance enhanced TPU/TPE may be utilized in the direct manufacturing of products. Various examples include:

i. gel bracelets or other jewelry (such as pendants or rings) scented in designer or favorite fragrances;

ii. “scratch and sniff” books updated from scented stickers with limited lifespans to permanently scented gel stickers;

iii. fragranced gel stickers to be utilized as temporary, portable scented decorative accents on personal items (i.e., notebooks, cell phones, cell phone covers, eyeglass cases, CD cases, merchandise hang tags) or clothing;

iv. the use of fragranced TPU/TPE in clothing (lingerie) or other products which would benefit from scenting (perpetual “new car” smell in automobile dashboards, “aromatherapy” in cool eye patches, notebooks, cell phones, cell phone covers, eyeglass cases, CD cases, etc.).

The above are merely examples of the possibilities that may be enjoyed in accordance with at least one presently preferred embodiment of the present invention. For instance, it can be appreciated that a gel bracelet, disc, or square can be offered to customers in a department store by way of availing customers of the smell of different types of perfume. Such portable bracelets, discs or squares could then be retained by the customer for as long as is desired, whereupon the customer can “refer” to the scent of the given perfume at will on an ongoing basis. This could then compel the customer to return at a future juncture to actually purchase a bottle of the perfume. This could present the potential to retain interested customers rather than run the risk of repelling them through the aggressive sales tactics mentioned heretofore. In addition, to the extent the customers often avail themselves of a perfume's scent through tester bottles and strips, such a highly temporary, “one off” testing of the product may not be adequate to compel the customer to actually purchase the product. Instead, a portable “carrier” of the scent such as a gel bracelet, disc or square might well permit a customer to be thoroughly availed of a perfume's scent over a much longer period, thus helping the customer acclimatize to the scent and, in all likelihood, increase the possibility that the customer will then purchase the product.

It will further be appreciated that by encapsulating the scent in the thermoplastic, with the scent distributed substantially evenly throughout the thermoplastic, the scent will be fully infused in the thermoplastic and thus be long-lasting. Injection-molding processes for forming thermoplastics are well known; some examples can be found in the following: U.S. Pat. No. 4,781,554, issued Nov. 1, 1988; U.S. Pat. No. 4,439,390, issued Mar. 27, 1984; U.S. Pat. No. 4,400,341, issued Aug. 23, 1983; and U.S. Pat. No. 4,010,903, issued Mar. 8, 1977. Poured molding processes can also be employed for forming thermoplastics that can incorporate scents in accordance with at least one presently preferred embodiment of the present invention; some examples of poured molding processes can be found in the following: U.S. Pat. No. 4,193,134, issued Mar. 18, 1980; U.S. Pat. No. 3,980,747, issued Sep. 14, 1976; U.S. Pat. No. 3,927,162, issued Dec. 16, 1975; and U.S. Pat. No. 3,830,855, issued Aug. 20, 1974. Preferably, in each of these cases, a predetermined encapsulated scent will be added to the thermoplastic when the thermoplastic is in a liquid state and, via suitable mixing, it will be ensured that the scent is substantially evenly distributed throughout the thermoplastic material.

Preferably, it will also be the case that the concentration of scent in the thermoplastic is not so strong as to overwhelm the consumer. This can be tailored as deemed appropriate for the applications at hand but, for example, the concentration of scent can be configured so that, e.g., if a disc or square of gel containing the scent is provided on each of a large number of detergent boxes in a supermarket aisle, consumers will not be overwhelmed or inundated by scent as they are walking past the boxes.

The manufacture of chemically encapsulated fragrances or scents (often termed “microencapsulation” of same) is very well known, and a very wide variety of scents and fragrances that have been encapsulated by different processes may be employed within the scope of the embodiments of the present invention. For background purposes, some general examples of the encapsulation/microencapsulation of fragrances/scents may be found among the following exemplary and non-restrictive: U.S. Pat. No. 4,605,554, issued Aug. 12, 1986; U.S. Pat. No. 4,514,461, issued Apr. 30, 1 1985; U.S. Pat. No. 4,495,509, issued Jan. 22, 1985; U.S. Pat. No. 4,464,271, issued Aug. 7, 1984; and U.S. Pat. No. 4,446,032, issued May 1, 1984.

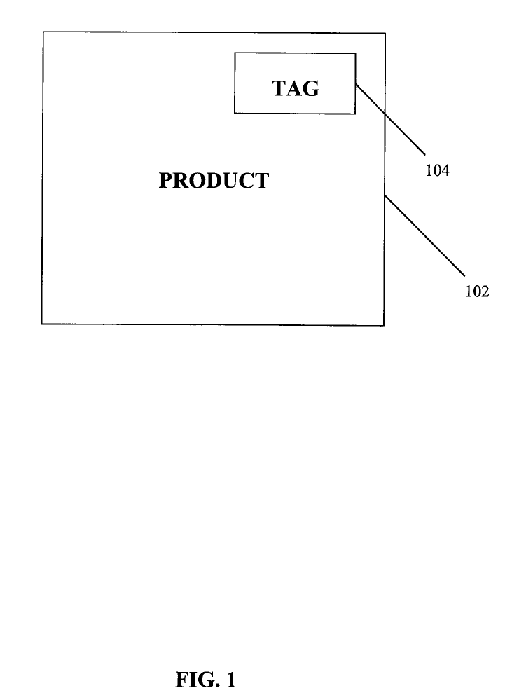

Referring now to FIG. 1, indicated at 102 is a product, which may include any of a wide variety of different types of packaging (e.g., box, bottle, jar), on which is mounted a tag comprising scented material 104. The tag of scented material 104 itself can preferably be affixed onto the product or, e.g., embedded in the product such as via seamlessly integrating it with the product (e.g., recessing it into product packaging or a product lid).

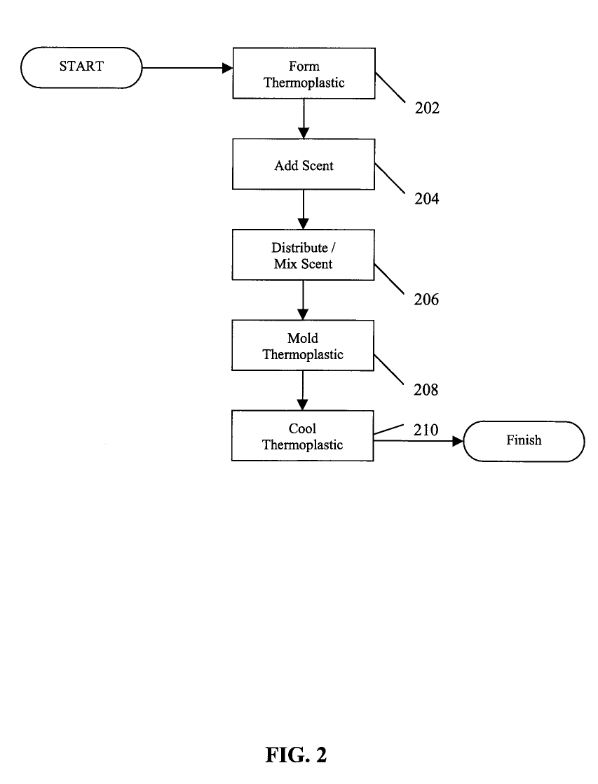

As shown in FIG. 2, the scented material itself is preferably formed via: forming thermoplastic in a liquid state (202); incorporating (adding) the scent into the thermoplastic (204); distributing the scent substantially evenly throughout the thermoplastic, e.g., via mixing (206); molding the thermoplastic (208), e.g., via a poured molding or injection molding process; and cooling the thermoplastic (210), now enhanced with scent.

While scented material formed in a manner as discussed hereinabove can be applied to product packaging, it can also form a product in its own right. Accordingly, a portable scent-enhanced product can find many uses, mere examples of which are outlined in items i-iv further above. The portable scent-enhanced product can take any of a very wide variety of shapes including, but by no means limited to: a disc, a rectangle, a triangle, an indeterminate two-dimensional shape, and a general toroidal shape. As in the product marking application discussed above, the portable scent-enhanced product can be adapted for being affixed to a surface, e.g., via an adhesive that can be exposed via peel-back paper.

It should further be appreciated that, as broadly contemplated, a portable scent-enhanced product comprises can take the form of a wearable scent-enhanced product, such as scent-enhanced thermoplastic jewelry. As mentioned further above, such jewelry can take the form, e.g., of a thermoplastic bracelet, but could also take the form of, e.g., a pendant, a ring, earrings, or any of a very wide variety of other possible wearable jewelry items.

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. A method of marking a product with scent, said method comprising the steps of:
providing a product;
providing a scent associated with the product;
incorporating the scent into a thermoplastic, wherein the scent is distributed substantially evenly throughout the thermoplastic;
obtaining a piece of the thermoplastic; and
incorporating the piece of thermoplastic with the product.

2. The method according to claim 1, wherein said incorporating comprises affixing the piece of thermoplastic to the product.

3. The method according to claim 2, wherein the product comprises packaging, said adhering step comprises affixing the piece of thermoplastic to the packaging.

4. The method according to claim 1, wherein said incorporating comprises embedding the piece of thermoplastic in a portion of the product.

5. The method according to claim 4, wherein the product comprises packaging, said embedding step comprising embedding the piece of thermoplastic in the packaging.

6. The method according to claim 1, wherein the thermoplastic comprises a thermoplastic taken from the group consisting essentially of: thermoplastic elastomer, thermoplastic urethane and polyurethane.

7. The method according to claim 1, wherein the scent comprises an encapsulated scent.

8. A method of providing a scent-enhanced product, said method comprising the steps of:
providing a predetermined scent;
incorporating the scent into a thermoplastic, wherein the scent is distributed substantially evenly throughout the thermoplastic; and
forming the thermoplastic into a scent-enhanced product.

9. The method according to claim 8, wherein said forming step comprises forming a portable scent-enhanced product.

10. The method according to claim 9, wherein the portable scent-enhanced product has a general shape taken from the group consisting essentially of: a disc, a rectangle, a triangle, an indeterminate two-dimensional shape, a general toroidal shape.

11. The method according to claim 9, wherein the portable scent-enhanced product is adapted for being affixed to a surface.

12. The method according to claim 8, wherein said step of forming a portable scent-enhanced product comprises forming a wearable scent-enhanced product.

13. The method according to claim 8, wherein said step of forming a wearable scent-enhanced product comprises forming scent-enhanced thermoplastic jewelry.

14. The method according to claim 13, wherein said step of forming scent-enhanced thermoplastic jewelry comprises forming a scent-enhanced thermoplastic bracelet.

15. The method according to claim 8, wherein the thermoplastic comprises a thermoplastic taken from the group consisting essentially of: thermoplastic elastomer, thermoplastic urethane and polyurethane.

16. The method according to claim 8, wherein the scent comprises an encapsulated scent.

17. A scented material comprising:
a predetermined encapsulated scent; and
a thermoplastic;
said scent being distributed substantially evenly throughout the thermoplastic.

18. The scented material according to claim 17, wherein said scented material is adapted for being affixed to a surface.

19. The scented material according to claim 17, wherein said scented material comprises a wearable scent-enhanced product.

20. The scented material according to claim 17, wherein said wearable scent-enhanced product comprises scent-enhanced thermoplastic jewelry.

21. The scented material according to claim 17, wherein the thermoplastic comprises a thermoplastic taken from the group consisting essentially of: thermoplastic elastomer, thermoplastic urethane and polyurethane.
